(19) United States
(12) Patent Application Publication
(10) Pub. No.: US 2019/0333141 A1
(43) Pub. Date: Oct. 31, 2019

(54) SYSTEM AND METHOD FOR IMPLEMENTING CUSTOMER EXPOSURE MANAGEMENT TOOL

(71) Applicant: JPMorgan Chase Bank, N.A., New York, NY (US)

(72) Inventors: Dennis BOWERS, Middletown, DE (US); Ramesh SWAIN, Ashburn, VA (US); Vishal SAXENA, Bear, DE (US); Ben FERENCHAK, Newark, DE (US); Michael J. GIULIANI, Wilmington, DE (US); Elizabeth Pierce VARHUS, Garnet Valley, PA (US)

(21) Appl. No.: 15/964,429

(22) Filed: Apr. 27, 2018

(51) Int. Cl. G06Q 40/02; G06Q 30/02

(52) U.S. Cl. CPC G06Q 40/025; G06Q 30/0201

(57) ABSTRACT

The invention relates to a customer exposure management system. The system comprises: a first input configured to receive operational data from a data ecosystem; a second input configured to receive risk derived data from a risk data source; a metadata repository; and a rule engine comprising a processor coupled to the first input, the second input and metadata repository and further configured to execute rules to: merge the operational data and risk derived data to generate a composite file on an account or customer basis; create one or more global attributes; identify an optimal income for the composite file; calculate a customer exposure strategy metric that defines an optimal exposure; select a strategy from a plurality of strategies wherein the strategy implements the one or more global attributes; apply the selected strategy to the composite file; and execute a corresponding account action.

### FIELD OF THE INVENTION

The invention relates generally to a customer exposure management tool that is business configurable and provides customer centric risk management.

### BACKGROUND OF THE INVENTION

A bank's risk management processes generally exist in a variety of separate business developed applications. Currently, these processes are disconnected, not particularly resilient, and require developers, code changes, and extensive testing to make any modifications. Multiple individual applications perform these functions in relative isolation with hard coded business logic. Current risk management strategies are more focused on accounts than an entire customer relationship. As a result, current systems experience outages, inconsistent customer treatments, and long wait times for changes to the business logic.

These and other drawbacks currently exist.

### SUMMARY OF THE INVENTION

According to one embodiment, the invention relates to a Customer Exposure Management System. The system comprises: a first input configured to receive operational data from a data ecosystem; a second input configured to receive risk derived data from a risk data source; a metadata repository; and a rule engine comprising a processor coupled to the first input, the second input and metadata repository and further configured to execute rules to: merge the operational data and risk derived data to generate a composite file on an account or customer basis; create one or more global attributes; identify an optimal income for the composite file; calculate a customer exposure strategy metric that defines an optimal exposure; select a strategy from a plurality of strategies wherein the strategy implements the one or more global attributes; apply the selected strategy to the composite file; and execute a corresponding account action.

According to another embodiment, a method for implementing a customer exposure management system comprising the steps of: receiving, via a first input, operational data from a data ecosystem; receiving, via a second input, risk derived data from a risk data source; merging, via a rules engine, the operational data and risk derived data to generate a composite file on an account or customer basis; creating, via the rules engine, one or more global attributes; identifying, via the rules engine, an optimal income for the composite file; calculating, via the rules engine, a customer exposure strategy metric that defines an optimal exposure; selecting, via the rules engine, a strategy from a plurality of strategies wherein the strategy implements the one or more global attributes; applying, via the rules engine, the selected strategy to the composite file; and executing, via the rules engine, a corresponding account action.

The system may include a specially programmed computer system comprising one or more computer processors, interactive interfaces, electronic storage devices, and networks.

The computer implemented system, method and medium described herein provide unique advantages to business users, according to various embodiments of the invention. An embodiment of the present invention is directed to accessing an entire customer and account base at a predetermined interval and perform a variety of risk and fraud related decisions based on customer and/or account conditions. These decisions may be made on per account basis as well as across customers who have multiple account and other relationships with an entity, such as a financial institution. The system provides multiple performance optimizations to ensure required activities to be performed in a single daily batch window. With the system, business rules may be directly configurable by the business thereby providing data agility to add new data elements for use in rules with minimal IT work. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a schematic diagram of a Customer Exposure Management System, according to an exemplary embodiment.

FIG. 2 illustrates an exemplary flowchart for implementing a Customer Exposure Management System, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs. While certain nomenclature and types of applications/hardware are described, other names and application/hardware usage is possible and the nomenclature provided is done so by way of non-limiting examples only. The figures provide additional exemplary details regarding the present invention. It should also be appreciated that these exemplary embodiments are provided as non-limiting examples only.

An embodiment of the present invention is directed to a Customer Exposure Management Tool that evaluates customers on a regular basis and performs a set of coordinated risk management strategies. An embodiment of the present invention seeks to treat customers in a holistic manner across a plurality of account and related relationships. Moreover, business rules and/or logic are directly, and rapidly, configurable by business users.

The Customer Exposure Management Tool may apply various strategies including: credit card line optimization; pre-qualification for additional credit product offers (e.g., card, mortgage, auto, etc.); high risk/potential high risk customer identification (e.g., credit and fraud, etc.); risk attribute creation; overdraft line of credit optimization; and credit originations decisioning. An embodiment of the present invention may further expand to include overdraft line management, Auto and Mortgage offer prequalification, credit decisioning for credit originations (credit Card, Auto loans, and Mortgages), Card reissuance decisioning, Reg Z 6-month review decisioning, daily (batch) fraud detection review. Other strategies may be supported by the various features of an embodiment of the present invention.

The Customer Exposure Management Tool may provide capabilities including: real-time credit line maintenance; real-time account closure and credit revocation; communicating offer prequalification results to offer presentation channel applications; real-time high-risk account tagging (to drive other authorizations and other strategies outside of CEMS); opening and routing credit review cases; opening and routing fraud review cases; triggering letters, account memos, and statement messages. The system may also include multiple simulation environments where a business can test rule changes against the production and user acceptance testing (UAT) data sets. Results may feed into an internal analytic data store for business analysis.

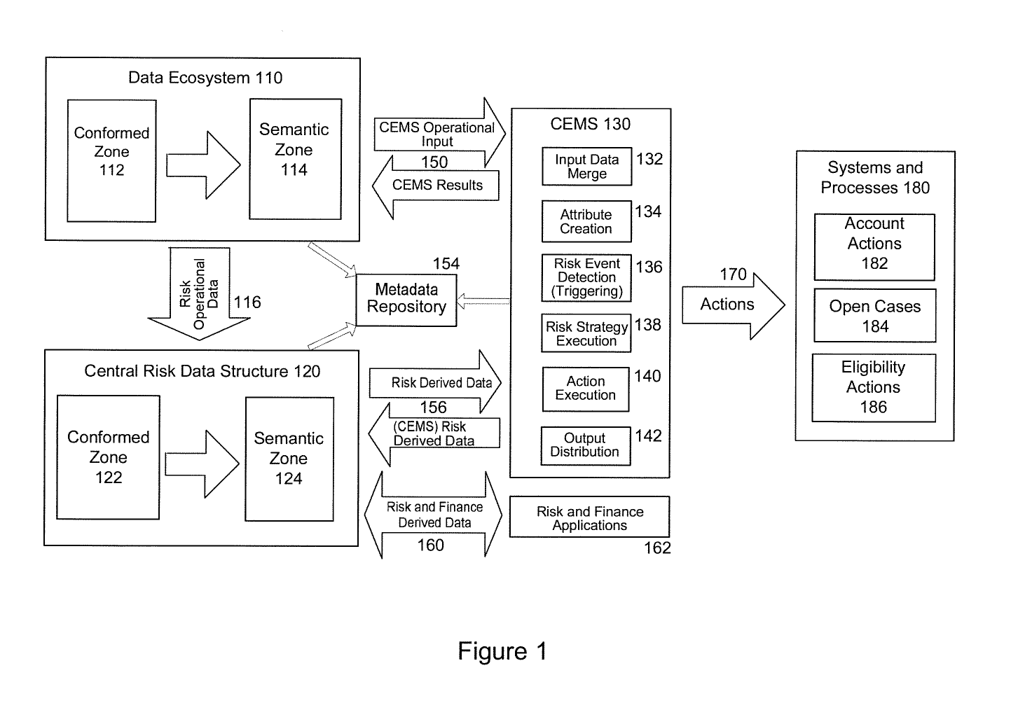

FIG. 1 illustrates a schematic diagram of a Customer Exposure Management System, according to an exemplary embodiment. Customer Exposure Management System (CEMS) may be implement a Portfolio Decision Platform that centralizes customer data into a business configurable decision platform that takes the necessary risk actions (e.g., change line, send to manual queue, send files to other production systems, etc.). Critical long term success factors may include data agility and system scalability. For example, data agility ensures the system keeps up with a changing environment. This may apply to economic, regulatory and other changes. System scalability may address customer and account volumes as well as an ability to further enhance the system to solve a next set of issues. FIG. 1 illustrates an exemplary embodiment in a financial services application. The system of an embodiment of the present invention may be applied to various other applications, scenarios, environments and uses.

An embodiment of the present invention is directed to accessing an entire customer and account base at a predetermined interval (e.g., daily, every night, periodic basis, etc.) and perform a variety of risk and fraud related decisions based on customer and/or account conditions. These decisions may be made on per account basis as well as across customers who have multiple account and other relationships with an entity, such as a financial institution. An embodiment of the present invention is directed to making decisions relating to: total exposure for a customer; whether the total exposure should be adjusted; potential high risk activity; whether a case should be opened; whether to stop approving authorizations; place indicators on authorization decisions that could trigger an event/investigation; initiate credit review cases, initiate fraud review cases, prequalify customers for credit, products, offers, etc. The system may also calculate custom attributes and apply the custom attributes later in decisioning. The decisioning may be performed on a daily or other periodic basis in a holistic manner. The system may also provide real-time decisions, e.g., real-time credit decisions. The system further enables a business (or other entity) to develop rules that relate to business strategies, as opposed to hard coded rules.

An embodiment of the present invention may utilize various rules to identify eligible accounts and/or customers. For example, a waterfall rule may identify a subset of accounts that may be eligible for a proactive line increase/decrease, targeted line increase/decrease and/or other action. The system may analyze various factors, metrics and/or scores. These rules may be configurable business rules. An embodiment of the present invention may provide a simulation environment where proposed rules may be executed against production data. The business may then modify the rules in response to the simulation.

As shown in FIG. 1, Customer Exposure Management System (CEMS) 130 seeks to resolve current gaps by leveraging centralized customer data in a Data Ecosystem 110 and Central Risk Data structure 120 and establishing a business configurable decision platform that delivers risk decisions consistently to various systems and processes, as shown by 180.

Data Ecosystem 110 may serve as an authoritative source for non-risk and finance data. Data Ecosystem 110 may include a Conformed Zone 112 that includes a supserset of data. Semantic Zone 114 may manage data relating to customers, accounts, financial data, authorization profile data, reprice data, retail OverDraft Protection (ODP), Non-Sufficient Fund (NSF), bureau data as well as other information. Semantic Zone 114 may represent data organized for consumption. Conformed zone may be used for data staging and Semantic zone may be used for data published for downstream process consumption.

Data Ecosystem 110 may provide an input of operational data to CEMS 130, via 150. CEMS 130 may also communicate results back to Data Ecosystem 110, via 150. Risk Operational Data may be communicated to Central Risk Data structure 120, via 116. Central Risk Data structure 120 may serve as an authoritative source for risk and finance derived data. Central Risk Data structure 120 may include a Conformed Zone 122 and Semantic Zone 124. Central Risk Data structure 120 may communicate risk derived data to and from CEMS 130, via 156.

A centralized repository may be maintained as shown by Metadata Repository 154. This Repository may manage data from Data Ecosystem 110, Central Risk Data structure 120 and CEMS 130.

CEMS 130 may include various modules and functions, represented by Input Data Merge 132, Attribute Creation 134, Risk Event Detection 136, Risk Strategy Execution 138, Action Execution 140 and Output Distribution 142. Actions may be communicated to Systems and Processes 180. For example, Systems and Processes 180 may represent a Consumer and Community Banking (CCB) System.

Input Data Merge 132 may initiate a data merge process from an operational input, via 150. The data received may be organized and used for rule processes. Input Data Merge 132 may also retrieve data for scores and risk segments, income data, customer data, account data from various sources, including Data Ecosystem 110 and Central Risk Data structure 120. Input Data Merge 132 may then flatten the data into a single record at a customer/account level. Rules may be executed against this single record. Attributes may be created by Attribute Creation 134. For example, attributes may represent average payment for last 12 months, number of new accounts opened past 12 months and number of accounts past due for 6 months or more. The attributes may be used by various strategies. Based on the applied business strategy, Risk Event Detection 136 may determine whether a particular customer or account should receive a line increase, a line decrease, a fraud case, a credit case and/or other strategy. Risk Strategy Execution 138 may then execute strategies. Action Execution 140 may apply various actions in response. Actions may include line increase, line decrease, memo creation, letter generation (e.g., a Dodd Frank letter), etc. Output Distribution 142 may then transmit output files back to Data Ecosystem 110, via 150. Output Distribution 142 may also send various files to an appropriate destination, e.g., for pre-approved offers as well as targeted line increase, a file may be sent to another system, such as Automated Credit Application Processing System (ACAPS). In this example, the system may indicate to the destination system that a customer is approved for a line increase and propose follow-up actions, such as a prompt for additional information from the customer.

For example, Action 170 may be executed by Systems and Processes 180. Systems and Processes 180 may perform various actions including Account Action 182, Open Cases Action 184 and Eligibility Actions 186. Account Actions 182 may include line increase, line decrease, memo, letter, account closure, authorization block, reissue, payfloat, re-price and other account related actions. Open Cases Actions 184 may include lending operations and fraud case creation. Eligibility Actions 186 may include segment suppression, balance transfer (BT), targeted line increase, prequalified offers, Portfolio Offer Engine (POE) tagging, upgrades, de-price and other eligibility related actions.

CCB Risk and Finance Applications 162 may represent Risk IT related Applications.

The system diagram of FIG. 1 is merely exemplary. Various other architectures may be applied. For example, an instance of a CEMS application may run on a distributed environment, another instance may run on a main frame and yet another instance may run in a big data environment to gather data. According to another example, the CEMS application may run in a data lake (or central risk data structure) environment which may be a Hadoop based environment. In this example, CEMS may run on edge nodes in the Hadoop environment.

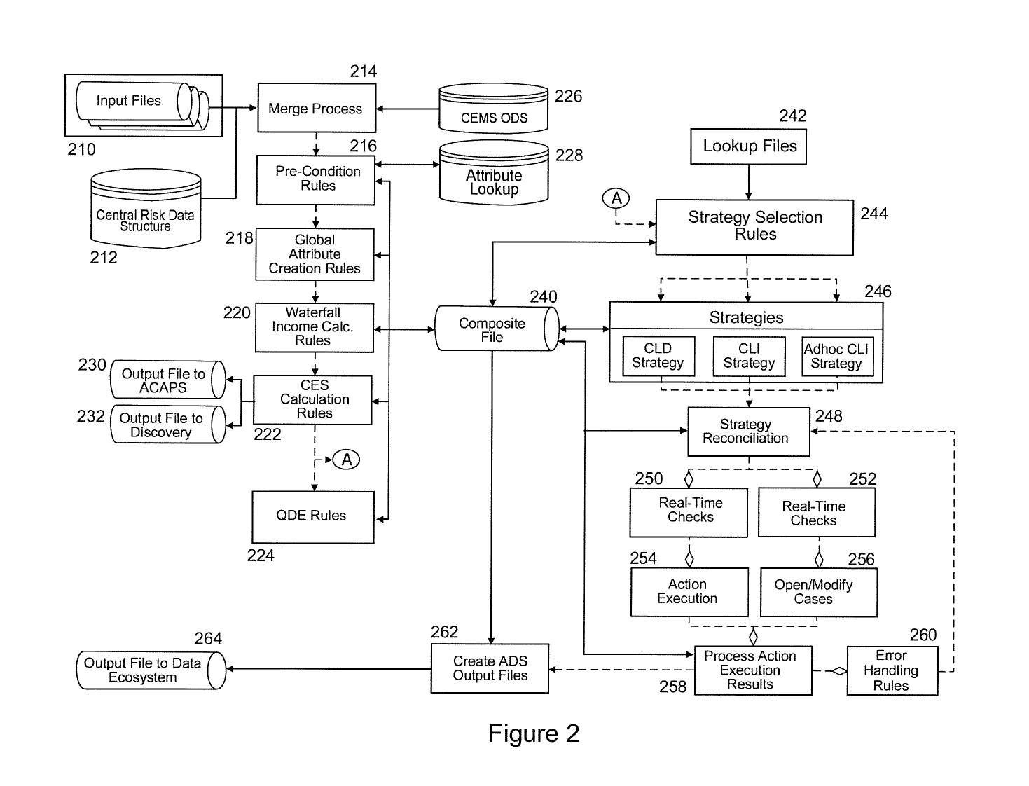

FIG. 2 illustrates an exemplary flowchart for implementing a Customer Exposure Management System, according to an embodiment of the present invention. The Customer Exposure Management System (CEMS) includes a Rules Engine that manages risk and exposure of portfolio population, such as a Card Services portfolio population. The Rules Engine of CEMS decreases time to market for risk strategies and decommission of legacy applications. The system increases operational efficiency and makes the operating model for the Risk Strategy Portfolio more sustainable. The order illustrated in FIG. 2 is merely exemplary. While the process of FIG. 2 illustrates certain steps performed in a particular order, it should be understood that the embodiments of the present invention may be practiced by adding one or more steps to the processes, omitting steps within the processes and/or altering the order in which one or more steps are performed.

FIG. 2 illustrates an exemplary processing flow for CEMS. Input Files 210 may be received as an input to Merge Process 214. Input Files 210 may represent data from various sources including a Data Ecosystem. Data Ecosystem may include data from various systems of records, including retail bank, enterprise systems, card services, mortgages, automobile finances, operations, credit business and vendors, corporate data. Merge Process 214 may also receive a feed from Central Risk Data structure 212. The feed may include risk scores, metrics and/or other risk related data. FIG. 2 illustrates an exemplary embodiment in a financial services application. Other sources of data may be implemented for various other applications, scenarios, environments and uses.

After Merge Process 214 receives inputs from 210, 212, CEMS may apply a sequence of rules to generate a Composite File 240. The Sequence may include Pre-Condition Rules 216, Global Attribute Creation Rules 218, Waterfall Income Calculation Rules 220, Customer Exposure Strategy (CES) Calculation Rules 222, Qualified Decision Engine (QDE) Rules 224, Strategy Selection Rules 244, Strategies 246, Strategy Reconciliation 248, Real-Time Checks 250, 252, Actions 254, 256 and Process Action Execution Results 258.

Pre-Condition Rules 216 may represent an initial ingestion of data elements from a Data Ecosystem and initial aggregations for downstream strategies. For example, multiple feeds may combine to form a Composite File 240.

Global Attribute Creation Rules 218 may be applied to perform an initial aggregation for downstream strategies and to setup various exclusions utilized by downstream strategies, such as High Risk Account Management (HRAM). For example, a number of attributes may be calculated or generated for use in strategies. The attributes may be published and available for use in other systems. Examples of global attributes may include: Customer Bureau months since unpaid reposession or foreclosure month count; Customer Bureau public record bankruptcy trade count; Customer Bureau ever bankrupt trade count, Customer Bureau last 24 months total unpaid chargeoff trade balance amount, and Customer Bureau last 24 months total unpaid chargeoff trade count.

Waterfall Income Calculation Rules 220 may define a disposable income at a customer level. Waterfall Income Calculation Rules 220 seeks to identify a best or optimal income to use in strategies for the customer.

Customer Exposure Strategy (CES) 222 may define an optimal exposure for customers. For example, CES 22 may identify a portfolio population, based on the Waterfall Income. The system may select accounts based on various triggers, conditions and other metrics. For high risk account maintenance, the system may identify accounts that need to be reviewed for credit and/or other analysis. CES 222 may identify a maximum exposure of card services for the customer.

Qualified Decision Engine (QDE) Rules 224 may pre-approve customers for various offers, programs, incentives. For example, QDE Rules 224 may pre-approve a customer for a card offer.

According to an embodiment of the present invention, the exemplary process may run daily (or at other intervals) to identify a set of accounts (e.g., Consumer and Business Card high risk accounts) using a customized Probability of Default (PD) model to enhance a business ability to manage Portfolio Risk through the Customer Exposure Management System (CEMS). In addition to the PD model, binary overlay rules may be applied to upgrade or downgrade the PD assessment.

Strategy Selection Rules 244 may access a set of files 242 to execute rules for strategy selection. For example, Strategy Selection Rules 244 may represent date triggers, account activity, account state triggers, next work date triggers, etc.

Strategies 236 may represent various business strategies. For example, strategies may include Account Maintenance Strategies and further support credit line decrease (CLD) strategy, credit line increase (CLI) strategy and Adhoc credit line increase (CLI) Strategy.

The system may identify which accounts should be considered for the various strategies based on rules. The business rules may identify a set of accounts to be considered for a particular strategy. For example, the business rules may identify a group of customers for a strategy that involves credit line decrease, credit line increase or HRAM. An exemplary strategy may include a High Risk Account Management (HRAM) strategy that covers systemic actions and manual referrals to Portfolio Risk Review (PRR) where internal and/or external factors indicate credit risk in Card Services. There are several components that support the HRAM systemic actions and manual referral strategy. The HRAM components may include credit line decrease (CLD) targeting, high risk scripting for global referrals, HRAM tags. The HRAM strategy maintains test and control groups to measure performance. The control accounts may be excluded from systemic action and manual review.

Strategy Reconciliation 248 may identify conflicting instances and then determine which strategy to apply. For example, this may occur when the system recommends the same account for an increase and decrease. In addition, Strategy Reconciliation 248 may include pre and post processing. For example, pre-reconciliation may run after executing strategies but before real-time checks. Strategy Reconciliation 248 may determine a “winning” strategy and apply a final action for an account. After determining the “winning” strategy, an appropriate Reason code and requested C3 Action or Manual review action may be set and then attached to a composite record.

Real-Time Checks 250 and 252 may include: Data Enrichment with Real Time account data. For example, CEMS may have an instance that runs on a mainframe that performs last minute real-time checks and takes action on the account. After real-time checks are applied, actions may be executed at 254 and cases may be opened or modified at 256. Other real-time checks and actions may be supported. CEMS may apply an appropriate strategy and identify a population of accounts that may be applied with an action.

Process Action Execution Results 258 may analyze action results. The results may be applied against Error Handling Rules 260 and further updated, organized and transmitted to Data Ecosystem via 264.

Output Files may be created at 262 and transmitted to Data Ecosystem, as shown by 264. The Output Files may be created for an Analytic Data Store (ADS). For example, a variety of datasets may be created. The system also supports real-time inquiries for pre-approved offers. CEMS may send data from pre-approved offers to vendors, e.g., suppliers, data vendors, marketing vendors, etc. The system may send targeted line increase data impressions by ACAPS. The system may also open fraud cases and apply migrating fraud strategies.

Error Handling Rules 260 may address various types of issues, including hardware issues, file issues and transaction failures. Hardware issues are possible but not likely, due to most of the servers being virtual. Virtual Servers make the platform resilient to Hardware failures. File Issues may refer to missing files depending on a criticality of the file, the process may wait until a cutoff time. For example, if the data is corrupt or has invalid data, depending on the criticality of the file, the process may use a previous version of the file or halt the run.

Transaction failures may refer to fields that are passed in the response from when CEMS connects to External Systems, such as C3 for Real-time Execution, SLD for Manual Generic Review, and SLD for Global Scripting. CEMS, in some cases, may try to resubmit after a certain amount of time, finally logging the error if it is unable to get a successful response from the external. A transaction failure process may be implemented for an outgoing connection to an external system. Transaction failure fields may indicate a success or failure, the type of task, the step where the transaction failures occurred and the description of the failure if any.

CEMS may also support a Simulation Environment where rules and attributes may be tested and analyzed against production data. For example, Simulation Environment may include a Rules Authoring and testing environment. The expectation is that rules be written and tested in a simulation environment, then published to another platform to action accounts. To run a Simulation, the user may choose which input files to use and which strategies to run. After a simulation, the user may select to compare the outputs of two or more runs. Other results and comparisons may be analyzed. The Simulation Environment may function within the CEMS and provide simulation results to the Data Ecosystem. Simulations may run in a UAT, Production and other environments.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although, the examples above have been described primarily as a web-based system, other embodiments of the invention can be implemented using similar technologies, such as transmission of data that is displayed using an existing web browser on a user's mobile device and using a software application (“app”) downloaded onto a user's mobile device.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A customer exposure management system comprising:
a first input configured to receive operational data from a data ecosystem;
a second input configured to receive risk derived data from a risk data source;
a metadata repository; and
a rule engine comprising a processor coupled to the first input, the second input and metadata repository and further configured to execute rules to:
merge the operational data and risk derived data to generate a composite file on an account or customer basis;
create one or more global attributes;
identify an optimal income for the composite file;
calculate a customer exposure strategy metric that defines an optimal exposure;
select a strategy from a plurality of strategies wherein the strategy implements the one or more global attributes;
apply the selected strategy to the composite file; and
execute a corresponding account action.

2. The system of claim 1, wherein the rules engine is configured to:
execute a reconciliation process that resolves a conflict between two or more strategies.

3. The system of claim 1, wherein the rules engine is configured to:
perform one or more real-time checks prior to executing the corresponding account action.

4. The system of claim 1, wherein the rules engine is configured to:
process action execution results.

5. The system of claim 1, wherein the rules engine is configured to:
create an output file; and
transmit the output file to the data ecosystem.

6. The system of claim 1, wherein the risk data source is a Hadoop based environment.

7. The system of claim 1, wherein the plurality of strategies comprise a combination of: credit card line optimization; pre-qualification for one or more credit product offers; high risk customer identification; risk attribute creation; overdraft line of credit optimization; and credit originations decisioning.

8. The system of claim 1, wherein the rules are configurable by a business user.

9. The system of claim 1, wherein the corresponding account action comprises at least one of: line increase, line decrease, letter generation, account closure, authorization block and reissue.

10. The system of claim 1, wherein the rules engine is configured to:
identify a population of accounts for the selected strategy.

11. A method for implementing a customer exposure management system comprising the steps of:
receiving, via a first input, operational data from a data ecosystem;
receiving, via a second input, risk derived data from a risk data source;
merging, via a rules engine, the operational data and risk derived data to generate a composite file on an account or customer basis;
creating, via the rules engine, one or more global attributes;
identifying, via the rules engine, an optimal income for the composite file;
calculating, via the rules engine, a customer exposure strategy metric that defines an optimal exposure;
selecting, via the rules engine, a strategy from a plurality of strategies wherein the strategy implements the one or more global attributes;
applying, via the rules engine, the selected strategy to the composite file; and
executing, via the rules engine, a corresponding account action.

12. The method of claim 11, further comprising the step of:
executing a reconciliation process that resolves a conflict between two or more strategies.

13. The method of claim 11, further comprising the step of:
performing one or more real-time checks prior to executing the corresponding account action.

14. The method of claim 11, further comprising the step of:
processing action execution results.

15. The method of claim 11, further comprising the steps of:
creating an output file; and
transmitting the output file to the data ecosystem.

16. The method of claim 11, wherein the risk data source is a Hadoop based environment.

17. The method of claim 11, wherein the plurality of strategies comprise a combination of: credit card line optimization; pre-qualification for one or more credit product offers; high risk customer identification; risk attribute creation; overdraft line of credit optimization; and credit originations decisioning.

18. The method of claim 11, wherein the rules are configurable by a business user.

19. The method of claim 11, wherein the corresponding account action comprises at least one of: line increase, line decrease, letter generation, account closure, authorization block and reissue.

20. The method of claim 1, further comprising the step of:
identifying a population of accounts for the selected strategy
